(19) United States
(12) Patent Application Publication
(10) Pub. No.: US 2007/0278249 A1
(43) Pub. Date: Dec. 6, 2007

(54) DISPOSABLE CONDIMENT DISPENSER SHIELD, SANITARY CONDIMENT DISPENSER SYSTEM AND METHODS FOR USING SAME

(76) Inventor: Jody E. Norem, Janesville, WI (US)

Correspondence Address: LATHROP & CLARK LLP, 740 REGENT STREET SUITE 400, P.O. BOX 1507, MADISON, WI, 537011507, US

(21) Appl. No.: 11/421,652

(22) Filed: Jun. 1, 2006

(51) Int. Cl. B67D 5/06; A47G 19/24

(52) U.S. Cl. 222/183; 222/565

(57) ABSTRACT

A shield that fits over the condiment dispenser protects the condiment dispenser from contamination. When using the condiment dispenser, a user contacts the shield rather than the condiment dispenser. A portion of the shield covers the dispensing hole(s) in the condiment dispenser the condiment is dispensed through. A covering portion of the shield is detached to expose the hole(s) and allow access to the condiments within the condiment dispenser. Perforations allow the covering portion to be detached from the remaining portions of the shield when the user manipulates the covering portion. A portion of the shield rests on a ledge portion of the condiment dispenser so that the shield remains relatively securely located around the condiment dispenser. A lip on an opening of the shield engages a ledge portion of the condiment dispenser to keep the shield on the condiment dispenser when the condiment dispenser and shield are picked up.

### BACKGROUND OF THE INVENTION

1. Field of the Invention

This invention is directed to systems, methods and devices that provide users of condiments with sanitary condiment dispensers.

2. Related Art

In the past few years, concerns about food-borne illnesses and the transfer of viruses, bacteria and the like from potentially contaminated food products, surfaces and serving articles to uncontaminated food and food consumers have become increasingly prevalent throughout the public. As a result, the use of latex gloves for food handlers in the food preparation industry is now ubiquitous. In fact, consumers are coming to expect food handlers in fast food restaurants and the like to wear latex gloves when handling food.

It has also been a long-standing practice in the food service industry to clean tables between seatings so that the subsequent patrons have a clean, attractive place to eat. As part of this table preparation, the various condiment dispensers that may be on the table, such as salt and pepper shakers, ketchup, mustard and sauce bottles, and the like, are rearranged, and may, rarely, be wiped down. However, it is more typical that the condiment dispensers are cleaned, if at all, only at the beginning or ending of the business day of the food service establishment, i.e., the restaurant.

### SUMMARY OF THE DISCLOSED EMBODIMENTS

Restaurant patrons expect that plates, glasses, silverware and the like will be washed and sanitized. Restaurant patrons also expect clean tables or tablecloths, tableware and the like. Restaurant patrons expect that the tables will be cleaned, or at least wiped down, to remove food residue and at least attempt to prevent contamination from the previous occupants. Most restaurant patrons also attempt to avoid transferring any disease-causing organisms to other patrons. For example, they tend to avoid open-mouthed or uncovered coughs or sneezes, spitting on the table and the like. They also expect the items they touch, such as tableware, glasses, silverware and the like, will be removed from the table before the next patrons are seated.

However, it is the rare restaurant patron that does not touch one or more of the condiment dispensers in the course of eating his or her meal. This often transfers food residues, such as grease and the like, to the condiment dispensers. If the patron has gotten bacteria or viruses on his or her hands, either while eating, while covering a cough or a sneeze, using the restroom without washing or via some other mechanism, the restaurant patron is likely to transfer bacteria or viruses to the condiment dispensers without thinking about it twice. This can unwittingly contaminate the outer surface of the condiment container with potentially disease-causing organisms. This contamination may be passed on to the next user if the condiment container is not cleaned after each use.

This invention provides a disposable shield for a condiment dispenser.

This invention separately provides a shield having a removable cover for a condiment dispenser.

This invention separately provides a condiment dispenser and a shield that can be detachably attached to the condiment dispenser.

This invention separately provides a shield for a condiment dispenser that covers opening(s) in the condiment dispenser.

This invention separately provides a shield for a condiment dispenser that has a removable portion that provides access to the opening(s) in the condiment dispenser.

This invention separately provides a disposable condiment shield for a condiment dispenser that contains decoration, a message or advertisement.

In various exemplary embodiments, a shield for a condiment dispenser fits over the condiment dispenser such that, when a restaurant patron uses the condiment dispenser, the restaurant patron comes into contact primarily with the shield and generally or typically does not come into contact with the condiment dispenser itself. In various exemplary embodiments, a portion of the shield covers the hole(s) or opening(s) in the condiment dispenser through which the condiment is dispensed. In various exemplary embodiments, the covering portion of the shield can be detached or removed from the remaining portions of the shield to expose the hole(s) or opening(s) and allow access to the condiments within the condiment dispenser. In various exemplary embodiments, perforations, cuts, adhesives or the like are provided to allow the covering portion to be readily detached from the remaining portions of the shield. In various exemplary embodiments, the shield is designed, both in its materials and in the shapes of the perforations, cuts or the like, such that, when a patron firmly twists or pulls on the covering portion relative to the rest of the shield, the covering portion readily detaches from the rest of the shield at the perforations or cuts, at the adhesive, or the like.

In various exemplary embodiments, a top or shoulder portion or the like of the shield rests on a top surface, a shoulder or a ledge portion of the condiment dispenser. In such exemplary embodiments, even after the covering portion is detached from the shield, the shield remains relatively securely located around the condiment dispenser. In various exemplary embodiments, a lip portion formed at an opening of the shield engages a ledge portion of the condiment dispenser such that the shield does not slide off of the condiment dispenser when the condiment dispenser and shield are picked up. In various exemplary embodiments, this opening is the opening through which the condiment dispenser is inserted into the interior of the shield. In various other exemplary embodiments, the bottom ledge of the condiment dispenser is replaced or combined with a groove or the like. The lip at the end of the opening in the shield fits into the groove to maintain the shield in a desired position around the condiment dispenser. In various exemplary embodiments, where the condiment dispenser does not have a ledge portion, and/or does not engage the top surface after the covering portion is removed or at all, the groove can be used to both keep the shield from falling down around the condiment dispenser after the detachable covering portion is detached and to keep the condiment dispenser from falling out of the shield when a user grasps and raises the shield to use and/or move the condiment dispenser.

In various exemplary embodiments, to use the condiment dispenser, a new, unused condiment dispenser shield is placed around a condiment dispenser that is lacking such a shield. In various exemplary embodiments, the condiment dispenser is inserted into an interior cavity formed in the shield. In various exemplary embodiments, inwardly projecting lip portions formed at the opening of the interior cavity of the condiment shield and, optionally, at least some portions of the shield are elastically or plastically deformed to allow the condiment dispenser to be fully inserted into the shield. The condiment dispenser, carrying the shield, is then placed back on the restaurant table. When the condiment dispenser is within the shield, in various exemplary embodiments, the openings in the condiment dispenser through which the condiment is dispensed are covered by the covering portion of the shield, if provided, so that the condiment cannot be dispensed.

To allow a user to dispense the condiment, the user grasps the body of the shield and of the condiment dispenser in one hand, and grasps the top, covering portion of the condiment shield with the other. The patron then firmly twists, pulls or otherwise manipulates the covering portion relative to the body portion of the shield to detach it from the shield. The patron can then dispense the condiment from the condiment dispenser. The patron can also dispose of the detached covering portion in any way she or he feels fit. However, should the patron's hands become contaminated with the food being consumed and/or with bodily fluids, such as by coughing, sneezing, inadvertently getting saliva onto them, or the like, when the user touches the condiment shield, the user does not transfer food residues or disease-causing bacteria from that patron's hands to the condiment dispenser body. Rather, if the user transfers anything, whatever is transferred is transferred only onto the shield.

After the patron has finished eating and has left the table, the wait-staff or bus-staff of the restaurant cleans the table of any food residue, and removes the consumed condiment shield from around the condiment dispenser. The wait-staff or bus-staff then replaces the consumed condiment shield with a new, unused condiment shield.

In various exemplary embodiments, after the detachable covering portion of the condiment shield has been removed, the condiment shield is supported by an inwardly projecting lip, which prevents the condiment dispenser from readily slipping out of the condiment shield when the condiment shield is lifted, and a shoulder portion that sits on a ledge or the like that is provided somewhere along the length of the condiment dispenser. The shoulder portion rests on the ledge portion, which prevents the condiment shield from sliding off the bottom of the condiment dispenser when the condiment dispenser is raised for a later use. The shoulder portion can be either above, below, or contiguous with the inwardly projecting lip or catch.

These and other features and advantages of various exemplary embodiments of systems, devices and methods according to this invention are described in, or are apparent from, the following detailed descriptions of various exemplary embodiments of various devices, structures and/or methods according to this invention.

### BRIEF DESCRIPTION OF DRAWINGS

Various exemplary embodiments of the systems, methods and devices according to this invention will be described in detail, with reference to the following figures, wherein:

FIG. 1 is a side plan view of a condiment dispenser and a side cross-sectional view of a condiment dispenser shield according to this invention.

FIG. 2 is a perspective view of the condiment dispenser and the condiment dispenser shield shown in FIG. 1;

FIG. 3 shows a portion of the plan and cross-sectional view of FIG. 1 in greater detail, as the condiment dispenser shield is placed around the condiment dispenser where the shield is not fully engaged on the retainer ledge;

FIG. 4 shows the portion of the side plan and cross-sectional view of FIG. 3, showing the condiment dispenser and condiment dispenser shield of FIG. 1 in greater detail when fully engaged on the retainer ledge;

FIG. 5 is a perspective view showing the first exemplary embodiment of the condiment dispenser shield with the detachable covering portion detached from the condiment dispenser shield;

FIG. 6 is a perspective view of one exemplary embodiment illustrating how the used condiment dispenser shield is removed from around the condiment dispenser;

FIG. 7 illustrates a second exemplary embodiment of a condiment dispenser and a second exemplary embodiment of a condiment dispenser shield according to this invention;

FIG. 8 is a side plan and cross-sectional view of a third exemplary embodiment of a condiment dispenser and a third exemplary embodiment of a condiment dispenser shield according to this invention;

FIG. 9 is a perspective view illustrating how the condiment dispenser shield shown in FIG. 8 fits around the condiment dispenser shown in FIG. 8;

FIG. 10 shows the third exemplary embodiment of the condiment dispenser shield with the detachable covering portion detached from the condiment dispenser shield;

FIG. 11 illustrates a fourth exemplary embodiment of a condiment dispenser and a fourth exemplary embodiment of a condiment dispenser shield according to this invention;

FIG. 12 shows the fourth exemplary embodiment of the condiment dispenser shield with the detachable covering portion detached from the condiment dispenser shield;

FIG. 13 illustrates a fourth exemplary embodiment of a condiment dispenser and a fifth exemplary embodiment of a condiment dispenser shield according to this invention;

FIG. 14 shows the fifth exemplary embodiment of the condiment dispenser shield with the detachable covering portion detached from the condiment dispenser shield; and

FIG. 15 is a flowchart outlining one exemplary embodiment of a method for using a condiment dispenser shield according to this invention.

### DETAILED DESCRIPTION OF EXEMPLARY EMBODIMENTS

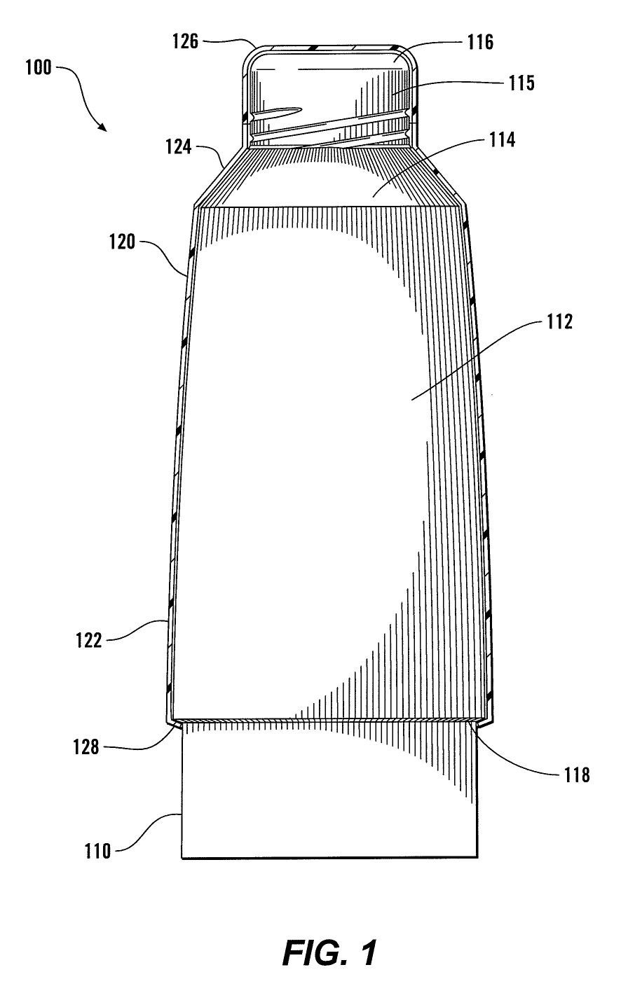

FIGS. 1-6 illustrate a first exemplary embodiment of a sanitary condiment dispenser system 100 according to this invention. As shown in FIG. 1, the sanitary condiment dispenser system 100 includes a condiment dispenser 110 and a sanitary condiment dispenser shield 120. In various exemplary embodiments, the condiment dispenser 110 is designed and manufactured specifically to work with the sanitary condiment dispenser shield 120. However, it should be appreciated that, in various other exemplary embodiments, the condiment dispenser 110 can be a standard, off-the-shelf condiment dispenser that need not been designed or manufactured with the sanitary condiment dispenser shield 120 in mind. Thus, the condiment dispenser 110 need not be intended to be used with the sanitary condiment dispenser shield 120. Likewise, while the sanitary condiment dispenser shield 120 will typically be designed and/or manufactured with a particular condiment dispenser 110 in mind, a particular sanitary condiment dispenser shield 120 can be used with any condiment dispenser 110 that it appropriately fits around, even if it was not specifically designed for that particular condiment dispenser 110.

As shown in the combined plan and cross-sectional view of the sanitary condiment dispenser system 100 shown in FIG. 1, in various exemplary embodiments, the condiment dispenser 110 includes a condiment dispenser body 112 and a dispenser portion 116. In the exemplary embodiment shown in FIG. 1, the dispenser portion 116 of the condiment dispenser 110 is located at the top end of the condiment dispenser body 112. In the exemplary embodiment shown in FIG. 1, the dispenser portion 116 includes a removable threaded top 115 that is threaded onto the condiment dispenser body 112.

However, it should be appreciated that, in various other exemplary embodiments, the dispenser portion 116 can be formed integrality with, and/or permanently attached to, the condiment dispenser body 112. In some such exemplary embodiments, a re-sealable opening can be provided at another location within the condiment dispenser body 112, such as within the base portion of the condiment dispenser body 112. Alternatively, the condiment dispenser 110 can be sealed, such that it cannot be refilled. Finally, in various exemplary embodiments, the dispenser portion 116 can be located at the bottom end of the condiment dispenser body 112, such as with pepper mills, salt mills and the like.

In various exemplary embodiments, a shoulder portion 114 or the like is provided at some point along the height of the condiment dispenser body 112. In the exemplary embodiment shown in FIG. 1, the shoulder portion 114 is located near a top of the condiment dispenser body 112, and, in this exemplary embodiment, between the main portion of the condiment dispenser body 112 and the dispenser portion 116.

Similarly, an outwardly-projecting, downwardly-facing ledge or the like 118 is also provided at some point along the height of the condiment dispenser body 112. In the exemplary embodiment shown in FIG. 1, the outwardly-projecting, downwardly-facing ledge 118 is located near the bottom of the condiment dispenser body 112. However, it should be appreciated that, in various other exemplary embodiments, the outwardly-projecting, downwardly-facing ledge 118 could have been located above, and/or contiguously with, the ledge or shoulder portion 114.

The sanitary condiment dispenser shield 120 is shown in cross-section, in FIG. 1. As shown in FIG. 1, the sanitary condiment dispenser 120 includes a shield body 122, a shoulder portion 124, a dispenser portion covering portion 126 and a lip or catch 128. In the exemplary embodiment shown in FIG. 1, the shield body 122 generally corresponds to the shape of the condiment dispenser body 112. In various exemplary embodiments, the shield body 122 closely fits to the exterior shape of the condiment dispenser body 112. In this case, by having the shield body 122 closely follow the condiment dispenser body 112, the user, when picking up the condiment dispenser 110 by gripping or grasping the sanitary condiment dispenser shield 120, will feel a relatively tight and secure grip on the condiment dispenser body 112. In the exemplary embodiment shown in FIG. 1, the shoulder portion 124 also closely parallels the shape of the shoulder portion 114.

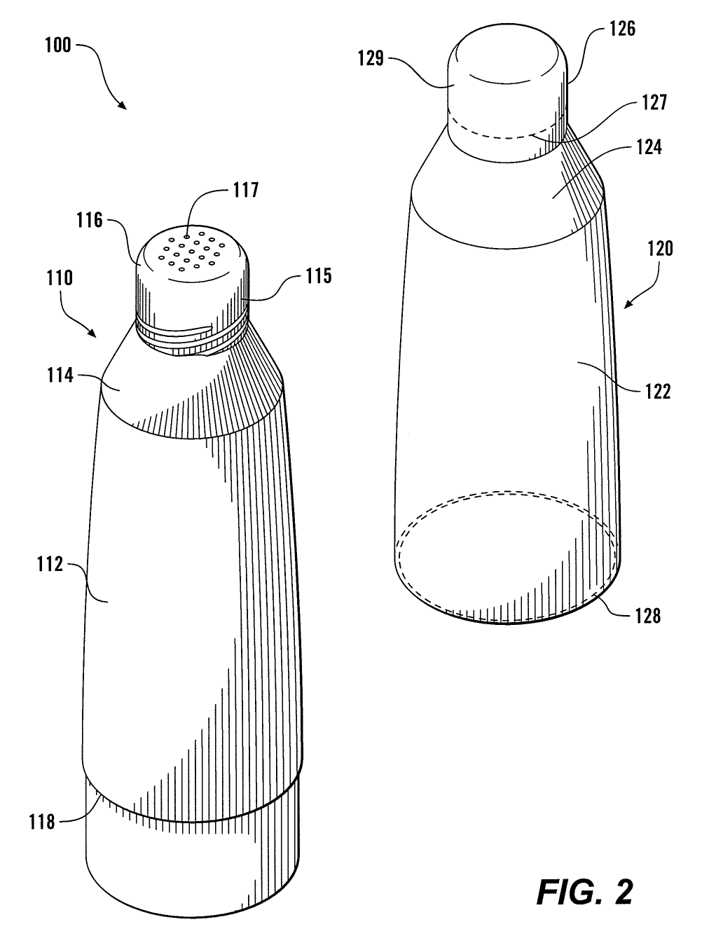

The dispenser portion covering portion 126 extends over or across the dispenser portion 116. In the exemplary embodiment shown in FIG. 1, the dispenser portion covering portion 126 does not have any holes, gaps or the like formed in it, near the holes 117 (see FIG. 2) formed in the dispenser portion. Accordingly, the dispenser portion covering portion 126 restricts any of the condiment stored within the condiment dispenser 110 from being dispensed. The dispenser portion covering portion 126 also reduces the ability of any contaminating aerosol particles from coming into contact with the dispenser portion 116 and/or the condiments stored within the condiment dispenser 110, as well as hindering a user, a guest or other patron from coming into contact with the dispenser portion 116.

In the exemplary embodiment shown in FIG. 1, the lip or catch 128 is formed as an inwardly projecting element formed at the bottom edge of the shield body 122. The shoulder portion 124 and the lip or catch portion 128 interact with the shoulder portion 114 and the outwardly-projecting, downwardly-facing ledge 118, respectively, to generally secure the sanitary condiment dispenser shield 120 relative to the condiment dispenser 110. That is, the shoulder portion 124, once it comes into contact with the shoulder portion 114, prevents the sanitary condiment dispenser shield 120 from moving or sliding further downward towards the bottom of the condiment dispenser body 112. Likewise, the lip or catch 128, prevents, or at least hinders, the condiment dispenser body 112 from disengaging from the sanitary condiment dispenser shield 120 and falling out through the open bottom of the condiment dispenser 110 when a user lifts the condiment dispenser 110 by gripping and raising the sanitary condiment dispenser shield 120. That is, in various exemplary embodiments, the condiment dispenser 110 does not readily separate from the condiment dispenser shield 120.

FIG. 2 shows perspective views of the condiment dispenser 110 and the correspondingly-shaped sanitary condiment dispenser shield 120 shown in FIG. 1. FIG. 2 shows the condiment dispenser body 112, the shoulder portion 114, the dispenser portion 116 and the ledge 118 in greater detail. Additionally, FIG. 2 shows that the dispenser portion 116 includes a plurality of condiment dispensing holes 117. When in normal use, the condiment dispensing holes 117 allow the condiments stored in the condiment dispenser 110 to be dispensed, such as onto the patron's food or the like. FIG. 2 also illustrates that, in various exemplary embodiments, the dispenser portion 116 comprises a threaded top 115 in which the condiment dispensing holes 117 are provided.

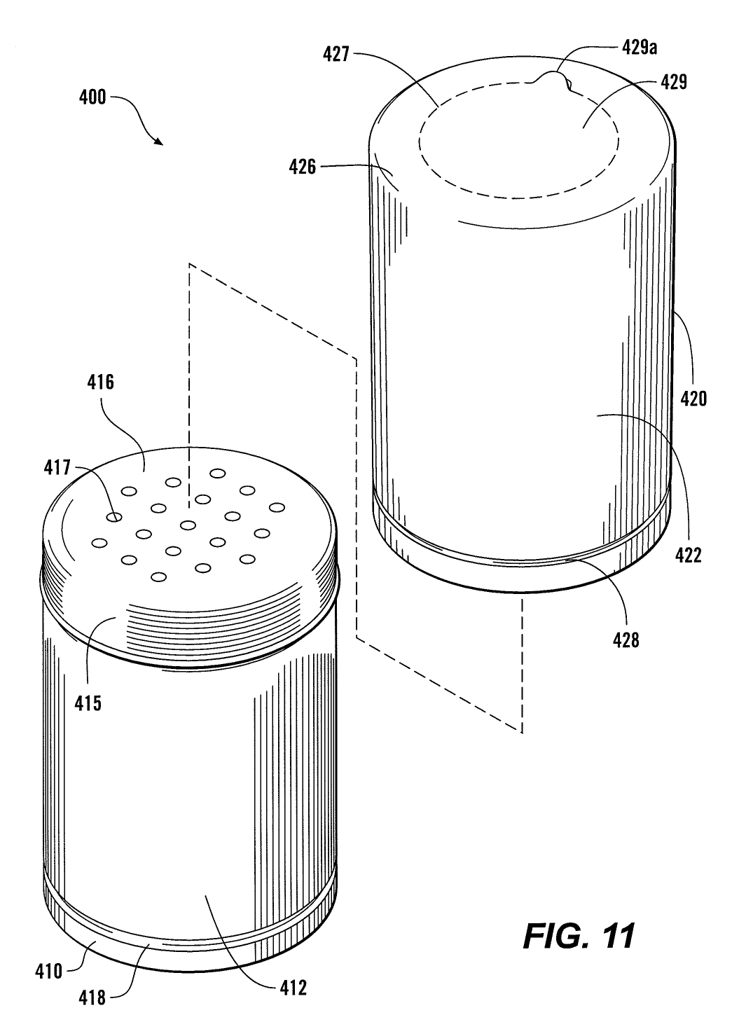

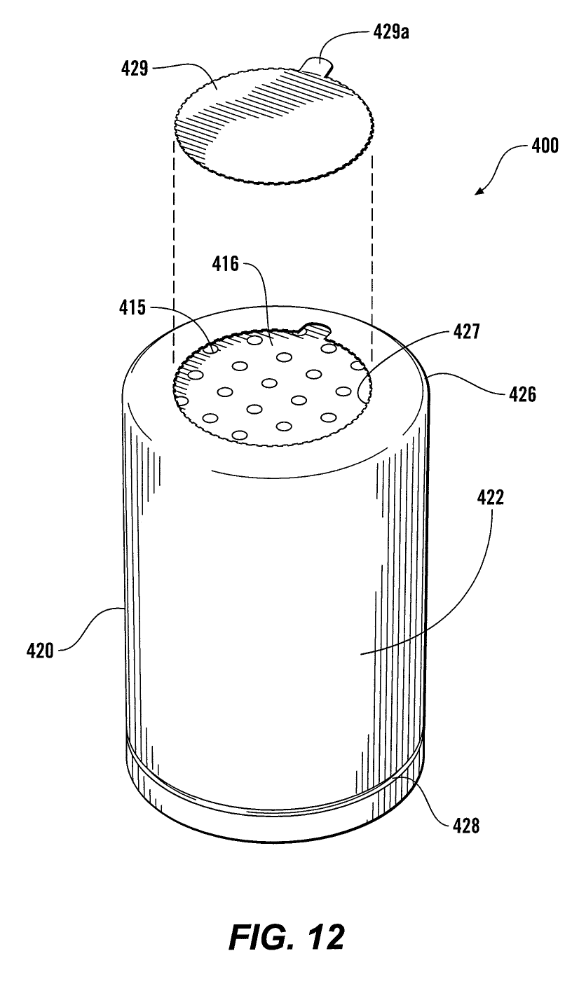

FIG. 2 also shows in greater detail a perspective view of the sanitary condiment dispenser shield 120, comprising the shield body 122, the shoulder portion 124, the dispenser portion 126 and the lip or catch 128. Additionally, as more clearly shown in FIG. 2, in various exemplary embodiments, a series of perforations or cuts 127 extend circumferentially around the dispenser portion covering portion 126. Thus, the perforations or cuts 127 create a detachable portion 129 of the dispenser portion covering portion 126. In various other exemplary embodiments, as shown in FIGS. 11 and 12, the perforations or cuts 127 define a detachable portion 129 of the condiment dispenser covering portion 126 that is adjacent to the dispensing holes 117, and that uncovers only the dispensing holes 117 when detached. In various exemplary embodiments, a user can use the perforations 127 to detach the detachable portion 129 from the dispenser portion covering portion 126 to reveal at least the dispensing holes 117 of the dispenser portion 116 of the condiment dispenser 110. By detaching the detachable portion 129, the user is able to dispense condiment contained within the condiment dispenser 110 through the condiment dispensing holes 117.

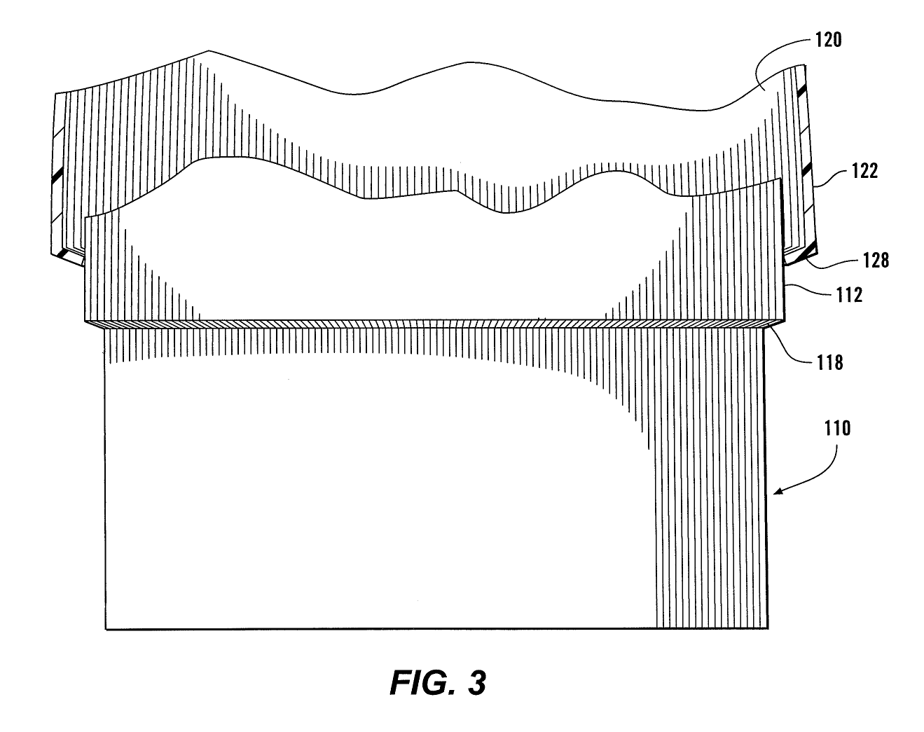

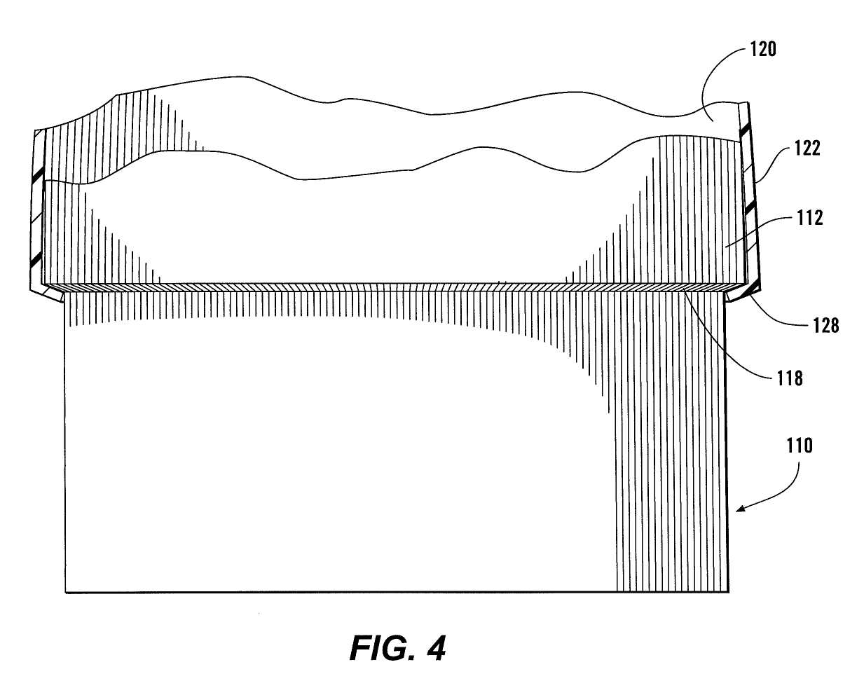

FIGS. 3 and 4 illustrate one exemplary embodiment of how the sanitary condiment dispenser shield 120 is placed around, and securely held to, the condiment dispenser 110. As shown in FIGS. 3 and 4, the condiment dispenser 110 is inserted into a cavity formed within the interior of the sanitary condiment dispenser shield 120. Alternatively, this same action can be described as slipping the sanitary condiment dispenser shield 120 down over the condiment dispenser 110. In either case, the condiment dispenser body 112 interacts with the inwardly projecting lip or catch 128 to slightly elastically or plastically deformed the lip or catch 128 and/or the bottom edge of the shield body 122 outwardly until the lip or catch 128 reaches the outwardly-projecting, downwardly-facing ledge 118. Of course, the relative locations of the shoulder portion 114 and the outwardly-projecting, downwardly-facing ledge 118 on the condiment dispenser 110 can be reversed. Accordingly, in this case, the locations on the sanitary condiment dispenser shield 120 of the shoulder portion 124 and the inwardly projecting lip 128 will also be reversed.

As shown in FIG. 4, at this point, the outwardly elastically deformed lip or catch 128 snaps or returns back to, or at least about, its undeformed state so that the lip catch 128 becomes securely positioned below the outwardly-projecting, downwardly-facing ledge 118. As a result, when a user picks up the sanitary condiment dispenser system 100 by grasping the sanitary condiment dispenser shield 120, the sanitary condiment dispenser shield 120 does not readily detach or disengage from the condiment dispenser 110 or vice-versa. Thus, the user does not need to consciously work at maintaining the condiment dispenser 110 within the sanitary condiment dispenser shield 120.

At the same time, when it becomes appropriate to remove the sanitary condiment dispenser shield 120 from around the condiment dispenser 110, such as after the sanitary condiment dispenser shield 120 has been used or to place a new or fresh sanitary condiment dispenser shield 120 around that condiment dispenser 110, this can be easily accomplished. In particular, in various exemplary embodiments, the user grasps, for example the bottom portion of the condiment dispenser 110 and the shield body 122 of the sanitary condiment dispenser shield 120. By giving the sanitary condiment dispenser shield 120 a firm tug or jerk upwardly away from the bottom of the condiment dispenser 110, the lip or catch 128 can be disengaged from the outwardly-projecting downwardly-facing ledge 118 and the used sanitary condiment dispenser shield 120 removed from around the condiment dispenser 110. The used condiment dispenser shield 120 can then be discarded.

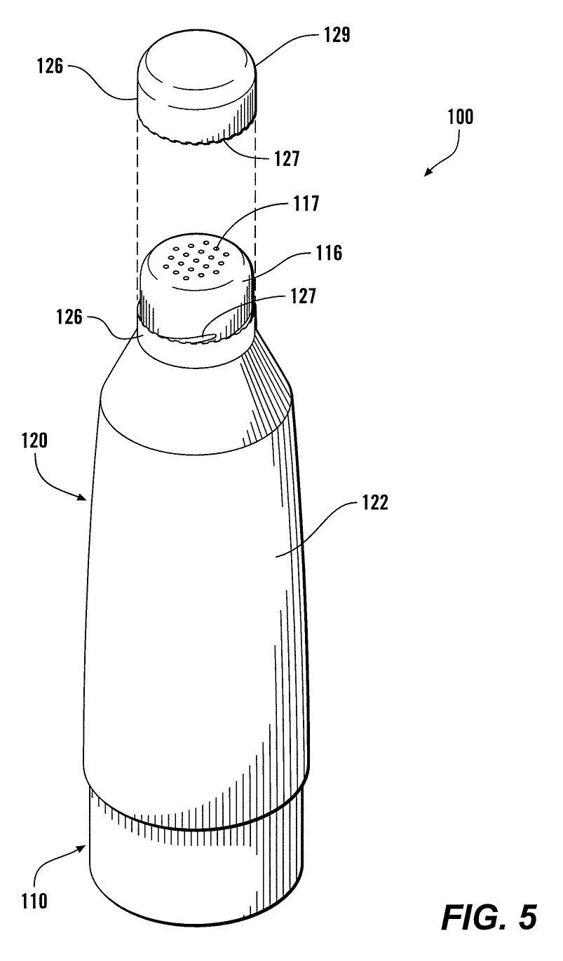

FIG. 5 illustrates how a user uses the sanitary condiment dispenser shield 120. As shown in FIG. 5, in its initial state, the sanitary condiment dispenser shield 120 extends over and covers the condiment dispensing holes 117 of the dispenser portion 116 of the condiment dispenser 110. To uncover the condiment dispensing holes 117, a user grasps the shield body of the sanitary condiment dispenser shield 120 with, for example, one hand and the detachable portion 129 of the dispenser portion covering portion 126 with, for example, the other hand. Then, by twisting, pulling on, or otherwise manipulating the detachable portion 129 relative to the rest of the dispenser portion covering portion 126 and the shield body 122 of the sanitary condiment dispenser shield 120 at or around the perforations or cuts 127, the detachable portion 129 can be torn away from the rest of the dispenser portion covering portion 126 and the shield body 122. As shown in FIG. 5, the detachable portion 129 is then lifted away from the sanitary condiment dispenser shield 120 and the condiment dispenser 110, revealing at least the condiment dispensing holes 117 of the dispenser portion 116. The user can then dispense the condiment contained in the dispenser body 110 through the condiment dispensing holes 117. If desired, the user can reset the detachable portion 129 on the shielded condiment dispenser to re-cover the condiment dispensing holes 117 while that user finishes his meal. Otherwise, the user can discard the detachable portion 129, so that, for example, the wait staff can more easily detect when the sanitary condiment dispenser shield 120 has been used and thus should be removed and replaced with a new, unused shield 120.

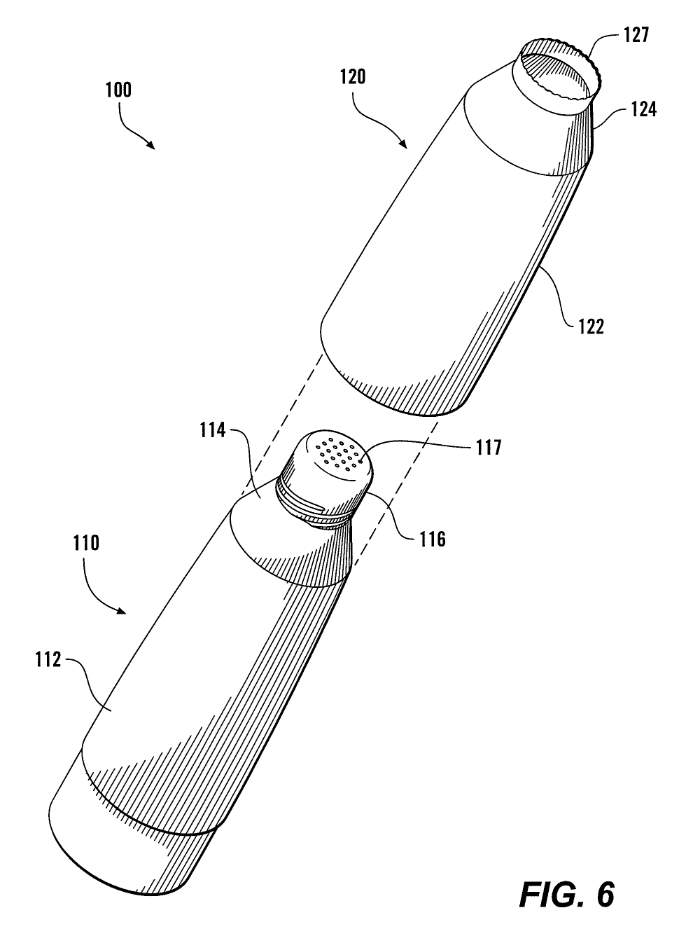

FIG. 6 illustrates one exemplary embodiment of removing a used or consumed sanitary condiment dispenser shield 120 from around a particular condiment dispenser 110, so that a new, unused sanitary condiment dispenser shield 120 can be placed around that condiment dispenser 110. After the user has finished using the used sanitary condiment dispenser system 100, the consumed sanitary condiment dispenser shield 120, which is no longer able to securely cover the condiment dispensing holes 117, can be removed from around the condiment dispenser 110 as described above. A fresh, unused sanitary condiment dispenser shield 120 can then be placed around the condiment dispenser 110.

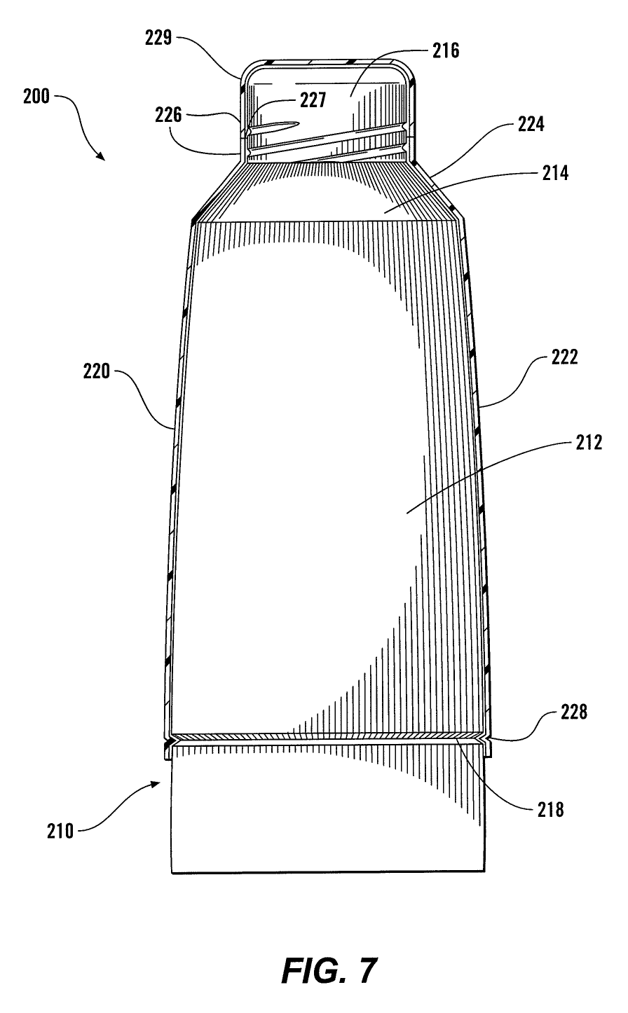

FIG. 7 shows a second exemplary embodiment of a sanitary condiment dispenser system 200 according to this invention. As shown in FIG. 7, the sanitary condiment dispenser system 200 includes a condiment dispenser 210 and a sanitary condiment dispenser shield 220. The condiment dispenser 210 includes a condiment dispenser body 212, a shoulder portion 214, and a dispenser portion 216. However, in place of the outwardly-projecting, downwardly-facing ledge 118 used in the first exemplary embodiment of the sanitary condiment dispenser system 100 shown in FIGS. 1-6, the second exemplary embodiment of the sanitary condiment dispenser system 200 includes a groove, channel or the like 218. While the second exemplary embodiment of the sanitary condiment dispenser system 200 shown in FIG. 7 shows the groove, channel or the like 218 formed at a bottom portion of the dispenser body 212, it should be appreciated that the groove, channel or the like 218 can be formed at any location along the length of the condiment dispenser 210, so long as a sanitary condiment dispenser shield 220 is able to appropriately interact with the groove, channel or the like 218.

Similarly, the sanitary condiment dispenser shield 220 includes a shield body 222, a shoulder portion 224, a dispenser portion covering portion 226, perforations 127 and a detachable portion 229 of the dispenser portion covering portion 226. However, in place of the lip or catch 128 used with the first exemplary embodiment of the condiment dispensing system 100, in this exemplary embodiment of the sanitary condiment dispenser shield 220, a lip, detent, catch or the like 228 extends inwardly from the shield body 222 It should be appreciated that the groove 218 can also be considered as a combination of the shoulder portion 114 and the outwardly-projecting, downwardly-facing ledge 118, with the outwardly-projecting, downwardly-facing ledge 118 above, and contiguous with, the shoulder portion 114. In this case, the detent 228 can be considered a corresponding combination of a lower shoulder portion 124 and an upper and contiguous, inwardly-projecting lip or catch 128.

It should also be appreciated that locations of the groove, channel or the like 218 formed in the dispenser body 212 and the lip, detent, catch or the like 228 provided on the shield body 222 can be reversed. In this case, an outwardly extending retaining structure can be provided on the dispenser body 212, while the groove can be provided on the shield body 222. In general, any of the ledge 118, the groove 218 and the like are first retaining structures on the dispenser body, while the lip, detent or catch 128 or 228, groove or the like are second retaining structures on the shield body.

In operation, as the sanitary condiment dispenser shield 220 is placed around the condiment dispenser 210, the inwardly-projecting lip, detent, catch or the like 228 is initially outwardly elastically and/or plastically deformed by the condiment dispenser body 212 until the inwardly-projecting lip, detent, catch or the like 228 reaches the groove, channel or the like 218. At that point, the inwardly-projecting lip, detent, catch or the like 228 at least partially elastically returns to its original state and securely engages with the groove, channel or the like 218 to securely hold the sanitary condiment dispenser shield 220 in place around the condiment dispenser 210.

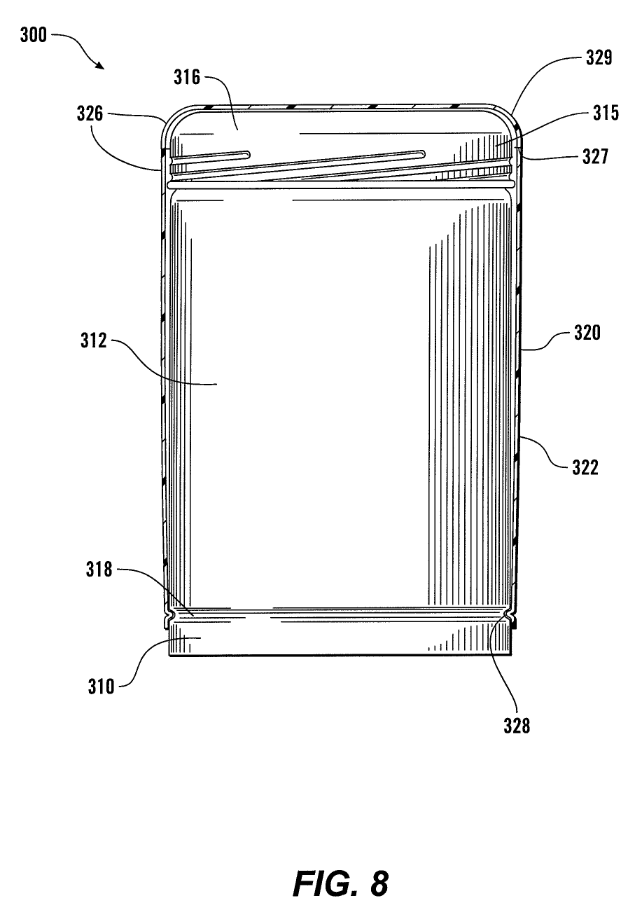

FIG. 8 illustrates a third exemplary embodiment of a sanitary condiment dispenser system 300 according to this invention. As shown in FIG. 8, the sanitary condiment dispenser system 300 includes a condiment dispenser 310 and a sanitary condiment dispenser shield 320. In this third exemplary embodiment, the condiment dispenser 310 includes a condiment dispenser body 312, a dispenser portion 316, including a threaded top 315 and a groove, channel or the like 328. However, it should be appreciated that, in this third exemplary embodiment of the sanitary condiment dispenser system 300, the condiment dispenser 310 generally lacks a shoulder portion 314. Alternatively, the condiment dispenser 310 can be viewed as having a shoulder portion that happens to lie within the dispenser portion 316.

Accordingly, the sanitary condiment dispenser shield 320 comprises a shield body 322, a dispenser portion covering portion 326 and a lip, detent, catch or the like 328. The sanitary condiment dispenser shield 320 also includes a detachable portion 329 of the dispenser portion covering portion 326 and a series of perforations or cuts 327 that define the detachable portion 329.

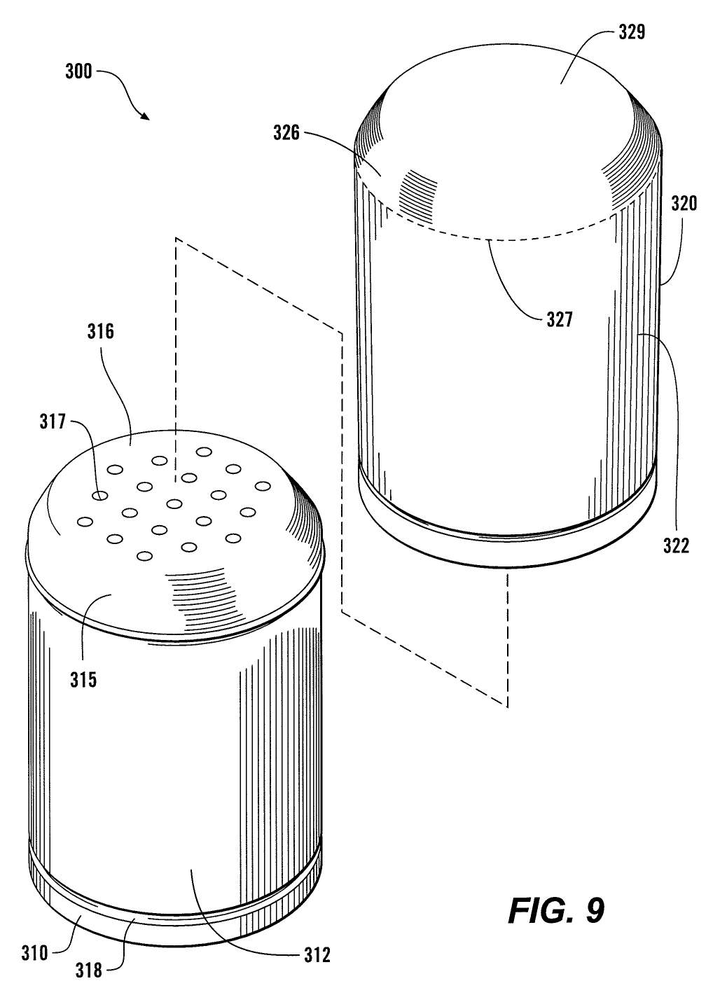

As shown in FIG. 9, the sanitary condiment dispenser shield 320, like the sanitary condiment dispenser shield 120, is placed over and around the condiment dispenser 310 such that the detachable portion 329 covers a series of condiment dispensing holes 317 formed in the threaded top 315 of the dispenser portion 316. When the sanitary condiment dispenser shield 320 is fully placed around the condiment dispenser 310, the lip, detent, catch or the like 328 engages with the groove, channel or the like 318 to secure the sanitary condiment dispenser shield 320 relative to the condiment dispenser 310.

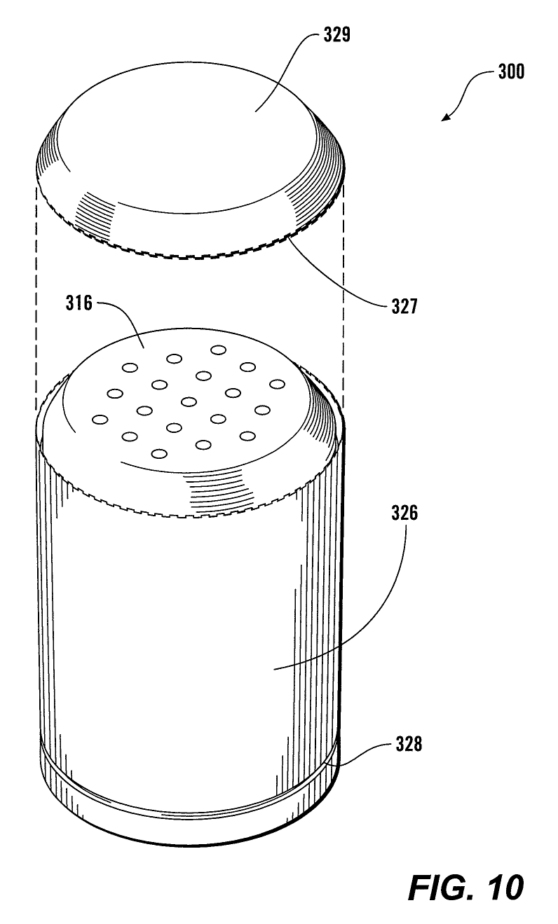

As shown in FIG. 10, the latch formed by the interaction of the lip, detent, catch or the like 328 with the groove, channel or the like 318 is particularly useful when the condiment dispenser 310 either completely lacks a shoulder portion or the shoulder portion is within the section of the dispenser portion 316 that is covered by the detachable portion 329. In this situation, as illustrated in FIG. 10, when the detachable portion 329 is detached from the dispenser portion covering portion 326 of the sanitary condiment dispenser shield 320, the latch formed by the interaction of the lip, detent, catch or the like 328 and the groove, channel or the like 318 prevents the sanitary condiment dispenser shield 320 from both falling out of the sanitary condiment dispenser shield 320 when the sanitary condiment dispenser system 300 is picked up as well as preventing the sanitary condiment dispenser shield 320 from falling down from around the condiment dispenser 310. The condiment dispenser 310 and the sanitary condiment dispenser shield 320 thus do not readily move relative to each other. Accordingly, the sanitary condiment dispenser shield 320 remains in place around the condiment dispenser 310 at least until the used or consumed sanitary condiment dispenser shield 320 is intentionally removed from around the condiment dispenser 310, for example to allow a new, unused sanitary condiment dispenser shield 320 to be placed around the condiment dispenser 310. The sanitary condiment dispenser shield 320 thus continues to shield and protect the condiment dispenser body 312 of the condiment dispenser 310 from becoming contaminated with grease, other food residues, and/or transfers of bacteria or viruses and the like from the user of the condiment dispenser 310.

FIG. 11 illustrates a fourth exemplary embodiment of a sanitary condiment dispenser system 400 according to this invention. As shown in FIG. 11, the sanitary condiment dispenser system 400 includes a condiment dispenser 410 and a sanitary condiment dispenser shield 420. In this exemplary embodiment, the condiment dispenser 410 includes a condiment dispenser body 412, a dispenser portion 416, including a threaded top 415 and a groove, a channel, an outwardly-projecting, downwardly-facing ledge or the like 418. However, it should be appreciated that, in this fourth exemplary embodiment of the sanitary condiment dispenser system 400, the condiment dispenser 410, like the condiment dispenser 310, generally lacks a shoulder portion 414.

The sanitary condiment dispenser shield 420 comprises a shield body 422, a dispenser portion covering portion 426 and an inwardly-projecting lip, a detent, a catch or the like 428. The sanitary condiment dispenser shield 420 also includes a detachable portion 429 of the dispenser portion covering portion 426 and a series of perforations or cuts 427 that define the detachable portion 429. As shown in FIG. 11, the perforations or cuts 427, rather than extending circumferentially around the condiment dispenser 410, define a closed curve that generally extends around the condiment dispensing holes 417 formed in the threaded top 415. In particular, the detachable portion 429 has a tab or similar structure 429a that can be grasped or held by a user. Because the undetached portions of the dispenser portion covering portion 426 extend over the top 416 of the condiment dispenser 410, the sanitary condiment dispenser system 400 can use any of the structures 118/128 or 218/228 shown in FIGS. 1-7 to keep the condiment dispenser 410 from falling out from inside of the sanitary condiment dispenser shield 420 when the sanitary condiment dispenser shield 420 is lifted by a user.

As shown in FIG. 12, in the fourth exemplary embodiment of the sanitary condiment dispenser system 400 shown in FIG. 10, even after the detachable portion 429 is detached from the dispenser portion covering portion 426 of the sanitary condiment dispenser shield 420, the dispenser portion covering portion 426 continues to prevent the sanitary condiment dispenser shield 420 from falling down around the condiment dispenser 410. The condiment dispenser 410 and the sanitary condiment dispenser shield 420 thus do not readily move relative to each other. Accordingly, the sanitary condiment dispenser shield 420 remains in place around the condiment dispenser 410, at least until the used or consumed sanitary condiment dispenser shield 420 is intentionally removed from around the condiment dispenser 310, for example to allow a new, unused sanitary condiment dispenser shield 420 to be placed around the condiment dispenser 410. The sanitary condiment dispenser shield 420 thus continues to shield and protect the condiment dispenser body 412 of the condiment dispenser 410 from becoming contaminated with grease, other food residues, and/or transfers of bacteria, viruses and the like from the user of the condiment dispenser 410.

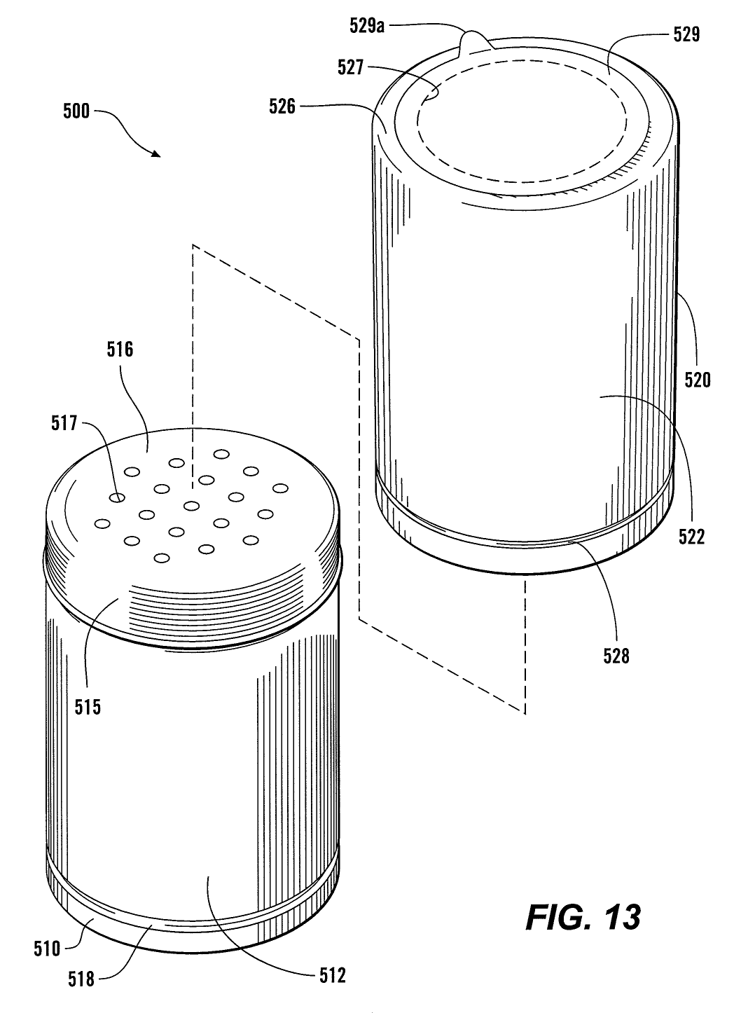

FIG. 13 illustrates a fifth exemplary embodiment of a sanitary condiment dispenser system 500 according to this invention. As shown in FIG. 13, the sanitary condiment dispenser system 500 includes a condiment dispenser 510 and a sanitary condiment dispenser shield 520. In this exemplary embodiment, the condiment dispenser 510 includes a condiment dispenser body 512, a dispenser portion 516, including a threaded top 515 and a groove, a channel, an outwardly-projecting, downwardly-facing ledge or the like 518. However, it should be appreciated that, in this fifth exemplary embodiment of the sanitary condiment dispenser system 500, the condiment dispenser 510, like the condiment dispenser 310, generally lacks a shoulder portion 514.

The sanitary condiment dispenser shield 520 comprises a shield body 522, a dispenser portion covering portion 526 and an inwardly-projecting lip, a detent, a catch or the like 528. The sanitary condiment dispenser shield 520 also includes a detachable portion 529 that covers a dispensing opening 527 provided in the dispenser portion covering portion 526. In this exemplary embodiment, the detachable portion 529 is a seal that is attached or mounted to the outer surface of the dispenser portion covering portion 526 using an adhesive, glue or other appropriate substance. As shown in FIG. 13, like the detachable portion 428, the detachable portion 529 has a tab or similar structure 529a that can be grasped or held by a user.

It should be appreciated that the seal-type detachable portion 529 can be paper, metal foil, a plastic film, or any other material that appropriately covers the dispensing opening 527. In various other exemplary embodiments, the seal-type detachable portion 529 is detachably mounted onto the dispenser portion covering portion 526 of the sanitary condiment dispenser shield 520 using an appropriate glue or other adhesive. In such exemplary embodiments, it is desirable that the seal-type detachable portion 529 be adversely affected when the seal-type detachable portion 529 is removed from the dispenser portion covering portion 526. This is advantageous, in that it tends to assure subsequent patrons that the seal-type detachable portion 529 has not been surreptitiously replaced onto the dispenser portion covering portion 526 of the sanitary condiment dispenser shield 520, to make it appear that the sanitary condiment dispenser shield 520 is new and uncontaminated. In various exemplary embodiments, the seal-type detachable portion 529 becomes physically altered when the seal-type detachable portion 529 is detached from the dispenser portion covering portion 526, similarly to a tamper-indicating security device. In various other exemplary embodiments, the adhesive, glue or the like used to detachably mount the seal-type detachable portion 529 to the dispenser portion covering portion 526 of the sanitary condiment dispenser shield 520, is designed such that, after the seal-type detachable portion 529 is detached from the dispenser portion covering portion 526 of the sanitary condiment dispenser shield 520, the adhesive is not capable of re-attaching the seal-type detachable portion 529 to the dispenser portion covering portion 526 of the sanitary condiment dispenser shield 520 so that a used sanitary condiment dispenser shield 520 is distinguishable from a new, unused sanitary condiment dispenser shield 520.

Because the dispenser portion covering portion 526 extends over the top 516 of the condiment dispenser 510, the sanitary condiment dispenser system 500 can use any of the structures 118/128 or 218/228 shown in FIGS. 1-7 to keep the condiment dispenser 520 from falling out from inside of the sanitary condiment dispenser shield 520 when the sanitary condiment dispenser shield 520 is lifted by a user.

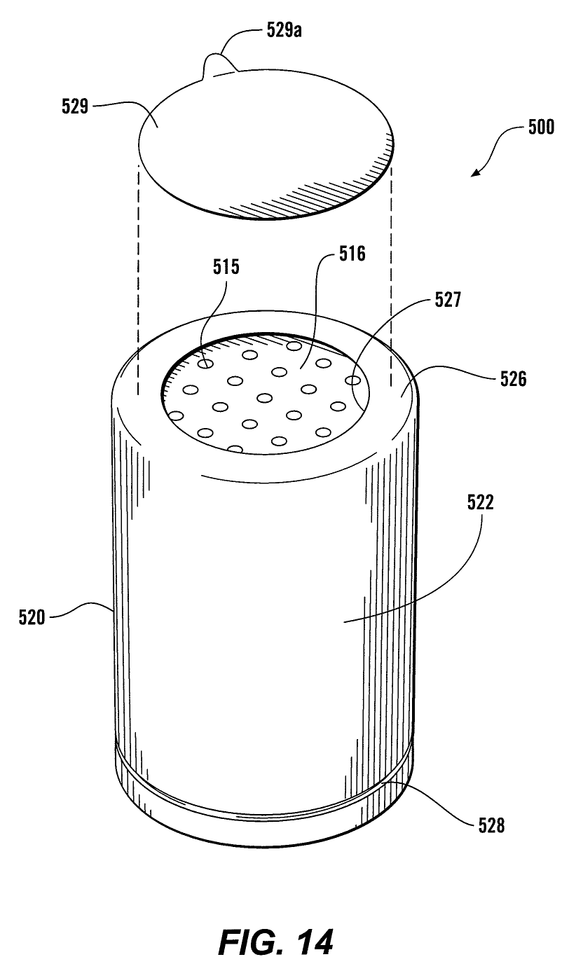

As shown in FIG. 14, in the fourth exemplary embodiment of the sanitary condiment dispenser system 500 shown in FIG. 10, even after the detachable portion 529 is detached from the dispenser portion covering portion 526 of the sanitary condiment dispenser shield 520, the dispenser portion covering portion 526 continues to prevent the sanitary condiment dispenser shield 520 from falling down around the condiment dispenser 510. The condiment dispenser 510 and the sanitary condiment dispenser shield 520 thus do not readily move relative to each other. Accordingly, the sanitary condiment dispenser shield 520 remains in place around the condiment dispenser 510, at least until the used or consumed sanitary condiment dispenser shield 520 is intentionally removed from around the condiment dispenser 510, for example to allow a new, unused sanitary condiment dispenser shield 520 to be placed around the condiment dispenser 510. The sanitary condiment dispenser shield 520 thus continues to shield and protect the condiment dispenser body 512 of the condiment dispenser 510 from becoming contaminated with grease, other food residues, and/or transfers of bacteria, viruses and the like from the user of the condiment dispenser 510.

It should be appreciated that, as can be envisioned in the perspective views shown in FIGS. 5, 10 and 14, the sanitary condiment dispenser shields 120, 220, 320, 420 and/or 520 can be clear, opaque and/or printed with a variety of text and/or graphic elements. In various exemplary embodiments, these text and/or graphic or decorative elements can be advertisements for particular food and/or beverage items of the particular restaurant in which the sanitary condiment dispenser system 100-500 is being used, other advertising messages from the food establishment, advertising messages from other business entities that have partnered with that particular food establishment, text and/or graphic messages that are designed to inspire or entertain or any other text and/or graphic elements that are desirably placed on the sanitary condiment dispenser shields 120, 220, 320, 420 and/or 520.

It should also be appreciated that, in the first-fifth exemplary embodiments 100-500 outlined above, it is desirable, although not necessary, that the sanitary condiment dispenser shields 120, 220, 320, 420 and/or 520 be sufficiently tapered that they can be easily and/or readily nested. This allows the sanitary condiment dispenser shields 120, 220, 320, 420 and/or 520 to be more densely packed for shipping and/or storage.

It should also be appreciated that, in the first-fifth exemplary embodiments 100-500 outlined above, a portion of the sanitary condiment dispenser shield 120, 220, 320, 420 or 520 is left uncovered by the sanitary condiment dispenser shield 120, 220, 320, 420 or 520. This allows the wait staff or other person to grasp the condiment dispenser 110, 210, 310, 410 or 510 in one hand and the sanitary condiment dispenser shield 120, 220, 320, 420 or 520 in the other hand. In this position, a simple tug or the like between the condiment dispenser 110, 210, 310, 410 or 510 and the sanitary condiment dispenser shield 120, 220, 320, 420 or 520 removes the sanitary condiment dispenser shield 120, 220, 320, 420 or 520 from around the condiment dispenser 110, 210, 310, 410 or 510.

In various other exemplary embodiments, the sanitary condiment dispenser shield 120, 220, 320, 420 and/or 520 can extend the full length of the condiment dispenser 110, 210, 310, 410 and/or 510. In some such exemplary embodiments, the a lip, detent, catch or the like 128, 228, 328, 428 and/or 528 can extend under the bottom edge of the condiment dispenser 110, 210, 310, 410 and/or 510, with the outwardly-projecting, downwardly-facing ledge, groove, channel or the like 118, 218, 318, 418 and/or 518 possibly omitted. In such exemplary embodiments, to allow the sanitary condiment dispenser shield 120, 220, 320, 420 or 520 to be easily and/or readily removed from the sanitary condiment dispenser shield 120, 220, 320, 420 or 520 from around the condiment dispenser 110, 210, 310, 410 or 510, another set of perforations, cuts or the like can be provided in the sanitary condiment dispenser shield 120, 220, 320, 420 or 520. Such another set of perforations, cuts or the like could extend along the length of the sanitary condiment dispenser shield 120, 220, 320, 420 or 520.

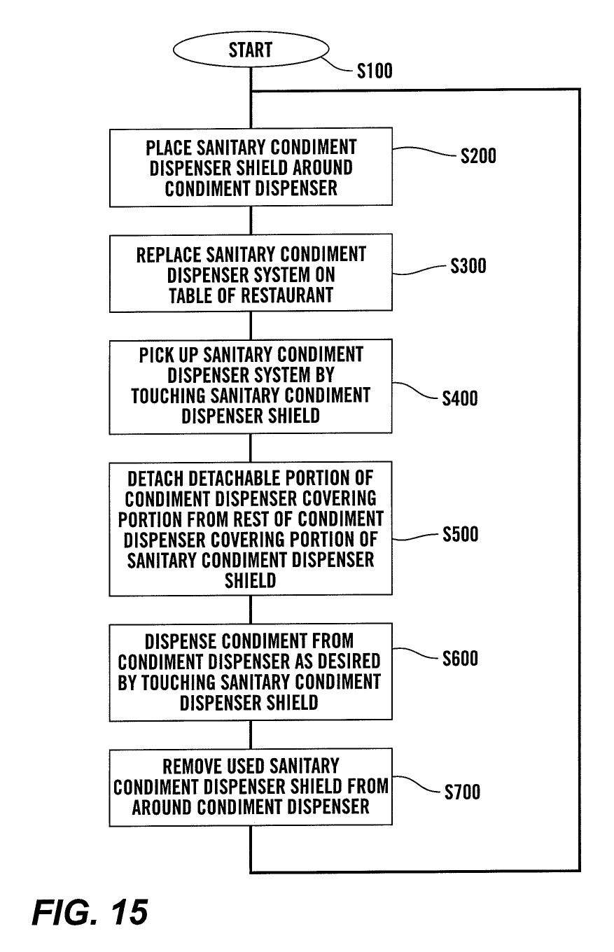

FIG. 15 is a flowchart outlining one exemplary embodiment of a method for protecting a condiment dispenser using a sanitary condiment dispenser shield according to this invention. As shown in FIG. 15, beginning in step S100, operation continues to step S200, where a sanitary condiment dispenser shield according to this invention is placed around a corresponding condiment dispenser. Then, in step S300, the sanitary condiment dispenser system, comprising the sanitary condiment dispenser shield around the condiment dispenser, is placed on a table or the like of a restaurant, a food service establishment, or the like. Next, in step S400, a user who has been seated at that table of the restaurant grasps the sanitary condiment dispenser system to open the sanitary condiment dispenser shield and gain access to the condiments within the condiment dispenser. Operation then continues to step S500.

In step S500, the user, after grasping the sanitary condiment dispenser system, twists, pulls or otherwise manipulates a detachable portion of the sanitary condiment dispenser shield relative to that sanitary condiment dispenser shield to detach the detachable portion from the sanitary condiment dispenser shield. Next, in step S600, the user dispenses the condiment by grasping or touching the sanitary condiment dispenser shield rather than the condiment dispenser itself, such that the condiment dispenser does not become contaminated as it is picked up and used or the like by the user. Then, in step S700, after the user has left the table or the like, the used sanitary condiment dispenser shield previously placed around the condiment dispenser is removed from around the condiment dispenser, such as to allow a new, unused, sanitary condiment dispenser shield to be placed around that condiment dispenser. Operation then returns to step S200.

While the first-fifth exemplary embodiments 100-500 outlined above are directed to rigid condiment dispensers 110, 210, 310, 410 or 510, it should be appreciated that any of the sanitary condiment dispenser shield 120, 220, 320, 420 or 520 could be modified for use with a flexible-body condiment dispenser, such as a needle-tipped or other type of squeeze bottle usable to dispense ketchup, mustard, mayonnaise, barbeque sauce, other sauces, honey and/or any other desired liquid or viscous material. It some such exemplary embodiments, it may be appropriate to form the sanitary condiment dispenser shield 120, 220, 320, 420 or 520 of a material that does not substantially interfere with the squeeze-ability of the flexible condiment dispenser.

While this invention has been described in conjunction with the exemplary embodiments outlined above, various alternatives, modifications, variations, improvements and/or substantial equivalents, whether known or that are or may be foreseen, may become apparent to those having at least ordinary skill in the art. Accordingly, the exemplary embodiments of the invention, as set forth above, are intended to be illustrative, not limiting. Various changes may be made without departing from the spirit or scope of the invention disclosed herein. Therefore, the invention is intended to embrace all known or earlier or later-developed alternatives, modifications, variations, improvements and/or substantial equivalents.

1. A condiment dispenser shield useable with a condiment dispenser having a first shape and at least one dispensing opening through which a condiment contained within the condiment dispenser can be dispensed, the condiment dispenser shield comprising:
a shield body, the shield body defining a cavity and having a second shape that is usable with the condiment dispenser having the first shape;
a first opening in the shield body, the condiment dispenser insertable into the cavity defined by the shield body through the first opening;
a cover element that is detachable from the shield body to provide a second opening in the condiment dispenser shield, wherein, when the condiment dispenser is within the condiment dispenser shield, after the cover element is detached from the shield body, at least one dispensing opening of the condiment dispenser is accessible to dispense the condiment from the condiment dispenser;
a retaining structure of the shield body that, when the condiment dispenser is within the condiment dispenser shield, interacts with a portion of the condiment dispenser to releasably maintain the condiment dispenser within the condiment dispenser shield.

2. The condiment dispenser shield of claim 1, wherein, when the condiment dispenser is within the condiment dispenser shield:
the condiment dispenser has a portion against which the condiment dispenser shield rests; and
the shield body of the condiment dispenser shield has a first portion that rests at least partially against that portion of the condiment dispenser.

3. The condiment dispenser shield of claim 2, wherein, when the condiment dispenser is within the condiment dispenser shield:
the portion of the condiment dispenser against which the condiment dispenser shield rests is a shoulder portion; and
the first portion rests at least partially against the shoulder portion of the condiment dispenser such that, after the cover element is detached, the condiment dispenser is not removable from the interior of the condiment dispenser shield through the second opening.

4. The condiment dispenser shield of claim 2, wherein
the portion of the condiment dispenser against which the condiment dispenser shield rests is a dispensing portion of the condiment dispenser through which the condiment is dispensed; and
the cover element is radially within a radial extent of the dispensing portion.

5. The condiment dispenser shield of claim 1, wherein, the cover element of the condiment dispenser shield is at least partially located above or within the first portion of the condiment dispenser shield.

6. The condiment dispenser shield of claim 5, wherein the cover element is radially within a radial extend of the first portion.

7. The condiment dispenser shield of claim 5, wherein the cover element is an upper portion of the first portion.

8. The condiment dispenser shield of claim 7, wherein the first portion is radially within a radial extent of the condiment dispenser.

9. The condiment dispenser shield of claim 5, wherein the cover element is co-extensive with the first portion.

10. The condiment dispenser shield of claim 9, wherein the first portion is radially within a radial extent of the condiment dispenser.

11. The condiment dispenser shield of claim 9, wherein the first portion extends radially outside of the condiment dispenser.

12. The condiment dispenser shield of claim 1, wherein the retaining structure comprises a first portion that interacts with a second retaining structure of the condiment dispenser and that acts to releasably retain the condiment dispenser within the condiment dispenser shield.

13. The condiment dispenser shield of claim 12, wherein:
the second retaining structure of the condiment dispenser is a ledge portion; and
the retaining structure is at least one of at least a lip or a catch that interacts with the ledge portion to restrain the condiment dispenser from exiting the condiment dispenser shield through the opening.

14. The condiment dispenser shield of claim 13, wherein the retaining structure extends inwardly from the shield body into the opening.

15. The condiment dispenser shield of claim 12, wherein the retaining structure extends radially inwardly from the shield body into the cavity and engages the second retaining structure of the condiment dispenser.

16. The condiment dispenser shield of claim 14, wherein:
the second retaining structure of the condiment dispenser is a groove; and
the retaining structure is at least one of at least a lip, a detent or a catch that interacts with the groove to restrain the condiment dispenser from exiting the condiment dispenser shield through the opening.

17. The condiment dispenser shield of claim 16, wherein the second retaining structure further acts to restrain the condiment dispenser from exiting the condiment dispenser shield through the second opening when the second opening is sufficient to otherwise allow the condiment dispenser to exit the condiment dispenser shield through the second opening.

18. The condiment dispenser shield of claim 1, further comprising at least one of at least one text element and at least one graphic element provided on at least the shield body.

19. The condiment dispenser shield of claim 18, wherein at least one of the at least one text element and the at least one graphic element forms at least one of at least one advertisement, at least one inspirational message, at least one informational message, at least one decoration and at least one humorous message.

20. The condiment dispenser shield of claim 1, wherein, the condiment dispenser shield is a sanitary condiment dispenser shield.

21. A condiment dispenser adapted for use with a condiment dispenser shield, comprising:
a condiment dispenser body having a first shape;
at least one condiment dispenser opening provided at one end of the condiment dispenser body, a condiment contained within the condiment dispenser dispensable through the at least one condiment dispenser opening; and
at least one first retaining structure formed on the condiment dispenser body, wherein, when the condiment dispenser shield is placed around the condiment dispenser, a second retaining structure of the condiment dispenser shield is able to interact with the first retaining structure to maintain the condiment dispenser shield around the condiment dispenser.

22. The condiment dispenser of claim 21, further comprising a dispenser portion that is removably attachable to the condiment dispenser body, the at least one condiment dispenser opening provided in the dispenser portion.

23. A condiment dispenser and condiment dispenser shield system, comprising:
a condiment dispenser body having a first shape;
at least one condiment dispenser opening provided at one end of the condiment dispenser body, a condiment contained within the condiment dispenser dispensable through the at least one condiment dispenser opening;
a shield body, the shield body defining a cavity and having a second shape that is usable with the condiment dispenser having the first shape;
a first opening in the shield body, the condiment dispenser inserted into the cavity defined by the shield body through the first opening;
a cover element that is detachable from the shield body to provide a second opening in the condiment dispenser shield, wherein, after the cover element is detached from the shield body, the at least one condiment dispensing opening is accessible to dispense the condiment from the condiment dispenser;
the shield body including a first retaining structure and the condiment dispenser including a second retaining structure, the first and second retaining structures interacting to releasably maintain the condiment dispenser within the condiment dispenser shield.
